(19) United States
(12) Patent Application Publication
(10) Pub. No.: US 2023/0351719 A1
(43) Pub. Date: Nov. 2, 2023

(54) METHOD AND ELECTRONIC DEVICE FOR DETERMINING OPTIMAL GLOBAL ATTENTION IN DEEP LEARNING MODEL

(71) Applicant: Samsung Electronics Co., Ltd., Suwon-si (KR)

(72) Inventors: Eega Revanth RAJ, Hyderabad (IN); Sai Karthikey PENTAPATI, Gurgaon (IN); Raj Narayana GADDE, Bangalore (IN); Anushka GUPTA, Bareilly (IN); Dongkyu KIM, Suwon-si (KR); Kwangpyo CHOI, Suwon-si (KR)

(21) Appl. No.: 18/315,072

(22) Filed: May 10, 2023

Related U.S. Application Data
(63) Continuation of application No. PCT/KR2023/005875, filed on Apr. 28, 2023.

(30) Foreign Application Priority Data
Apr. 28, 2022 (IN) 202241024996
Mar. 9, 2023 (IN) 2022 41024996

(51) Int. Cl. G06V 10/42; G06V 10/44; G06V 10/94

(52) U.S. Cl. CPC G06V 10/42; G06V 10/44; G06V 10/94

(57) ABSTRACT

An electronic device for determining global attention in a deep learning model is provided. The electronic device includes a hardware accelerator, a low-complex global attention generator, a parallel switch, and a series switch. The hardware accelerator is configured to process each tile of a full-frame image and the low complex global attention generator is configured to generate a channel attention map of the full-frame image. The parallel switch is configured to bypass a connection of the channel attention map with the hardware accelerator and a series switch, configured to gate the connection of the channel attention map with the hardware accelerator.

### CROSS-REFERENCE TO RELATED APPLICATION(S)

This application is a continuation application, claiming priority under § 365(c), of an International application No. PCT/KR2023/005875, filed on Apr. 28, 2023, which is based on and claims the benefit of an Indian Provisional patent application number 202241024996, filed on Apr. 28, 2022, in the Indian Intellectual Property Office, and of an Indian Complete patent application number 202241024996, filed on Mar. 9, 2023, in the Indian Intellectual Property Office, the disclosure of each of which is incorporated by reference herein in its entirety.

### TECHNICAL FIELD

The disclosure relates to an electronic device. More particularly, the disclosure relates to a method and the electronic device for low complex determination of global attention in a deep learning model.

### BACKGROUND ART

Complex deep learning networks are important for performing regression use cases such as image/video processing. However, the complex deep learning networks are suitable for implementation in electronic devices with high computational resources. Further, the electric power consumption of the complex deep learning networks is comparatively high. Thus, the complex deep learning networks are not feasible to be included in the electronic devices with limited electric power and computational resources. To overcome this challenge, development of hardware accelerators is ongoing which can be used for performing regression use cases.

The above information is presented as background information only to assist with an understanding of the disclosure. No determination has been made, and no assertion is made, as to whether any of the above might be applicable as prior art with regard to the disclosure.

### DISCLOSURE

### Technical Solution

The principal object of the embodiments herein of the disclosure are to address at least the above-mentioned problems and/or disadvantages and to provide at least the advantages described below. Accordingly, disclosure is to provide a method and an electronic device for determining global attention using a low-complex neural network. The low complex neural network is implemented in the electronic device that allows memory-efficient computation of the global attention for a hardware accelerator. The proposed implementation allows tile-based computation of a full-size image in the hardware accelerator without limiting the receptive field and does not compromise with optimality and quality gain provided by a SOTA global attention.

Another aspect of the disclosure is to provide a switchable network architecture that can turn on/off the global attention in the hardware accelerator based on a requirement of global attention for a particular use case.

Additional aspects will be set forth in part in the description which follows and, in part, will be apparent from the description, or may be learned by practice of the presented embodiments.

### DESCRIPTION OF DRAWINGS

The above and other aspects, features, and advantages of certain embodiments of the disclosure will be more apparent from the following description taken in conjunction with the accompanying drawings, in which:

FIG. 1 is an architectural diagram of a hardware accelerator, according to the related art;

FIG. 2 is an architectural diagram of an electronic device for determining global attention in a deep learning model in a low complex manner and switching the global attention, according to an embodiment of the disclosure;

FIG. 3A is a flow diagram illustrating a method for determining a global attention in the deep learning model, according to an embodiment of the disclosure;

FIG. 3B is a flow diagram illustrating a method for a switchable global attention, according to an embodiment of the disclosure;

FIGS. 4A and 4B illustrate example scenarios of processing a full-frame image using global attention, according to various embodiments of the disclosure; and

FIG. 5 is a block diagram of the electronic device determining a global attention map, according to an embodiment of the disclosure.

The same reference numerals are used to represent the same elements throughout the drawings.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Also, the various embodiments of the disclosure described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Throughout this disclosure, the terms “global attention map” and “channel attention map” are used interchangeably and mean the same.

Accordingly, the embodiments of the disclosure herein provide an electronic device for determining global attention in a deep learning model. The electronic device includes a hardware accelerator configured to process each tile of a full-frame image and a low complex global attention generator. The low complex global attention generator is configured to subsample the full-frame image using at least one of down sampling kernels or learned downsizing kernels, determine a channel attention map by providing the subsampled image to the deep learning model; and apply the channel attention map to deep learning features obtained while processing each tile of the full-frame image.

Accordingly, the embodiments of the disclosure herein provide the electronic device with switchable global attention. The electronic device includes the hardware accelerator, a global attention generator, a parallel switch, and a series switch, where the hardware accelerator is configured for processing each tile of a full-frame image. The global attention generator is configured for generating the channel attention map of the full-frame image. The parallel switch is configured for bypassing a connection of the channel attention map with the hardware accelerator. The series switch is configured for gating the connection of the channel attention map with the hardware accelerator.

Accordingly, the embodiments of the disclosure herein provide a low-complex method for determining the global attention in the deep learning model of the electronic device. The method includes subsampling, by the electronic device, the full-frame image using the fixed down sampling kernels or the learned downsizing kernels. The method includes determining, by the electronic device, a channel attention map by providing the subsampled image to the deep learning model and applying, by the electronic device, the channel attention map to deep learning features obtained while processing each tile of the full-frame image.

Accordingly, the embodiments of the disclosure herein provide a method for determining the global attention in the deep learning model of the electronic device using the low-complex network. The method includes receiving an input image and sub-sampling the input image to get a sub-sampled image. The method also includes reducing a size of the sub-sampled image using down sampling or downsizing kernels and determining an attention map using the reduced sub-sampled image. Further, the method includes obtaining a set of predetermined deep learning features from at least a portion of the input image and applying the calculated attention map to the obtained set of predetermined deep learning features.

The proposed method can be used to attain low complex global attention for a hardware-accelerated core block for neural network-based image and video processing use cases. The global attention is done using a subsampled version of the full-frame image. The subsampled image contains all low-frequency details that are crucial for extracting the global attention map. Loss of high-frequency details during the scale reduction of the full-frame image does not deteriorate the quality of the extracted global attention map, because the high-frequency details are suppressed via global averaging even in default implementations of the global attention.

According to an embodiment of the disclosure, the proposed method includes the determination of the global attention for the full-frame image using the subsampled version of the full-frame image in deep learning models that are executed on a singular and specialized electronic device, which maintains memory efficiency and power efficiency. Independence in computing the global attention from the hardware accelerator also allows reusability of the global attention map for modulating the global attention computation over each tile of the full input.

According to an embodiment of the disclosure, the proposed method allows a hardware accelerator of the electronic device to reuse the global attention for processing each tile of the full-frame image without limiting a receptive field and does not compromise with optimality and quality gain provided by a SOTA global attention. The tile-invariance of the global attention computation maintains an infinite receptive field of the hardware accelerator.

According to an embodiment of the disclosure, switchable global attention with fixed hardware implementation (i.e., without hardware modification) is adopted in the electronic device for turning on/off the global attention in the electronic device based on a requirement of the global attention for a particular use case.

This method describes the determination of the global attention in the deep learning model on the electronic device while having extremely low memory requirements. The reduced size of the full-frame image ensures memory requirement for calculating the attention map is reduced. The global attention is calculated only once per model execution instead of calculating the global attention in each block. The global attention is computed using the downscaled input instead of computing attention of the full image. Downscaling does not reduce the output quality of the electronic device, as all global characteristics of the full-frame image are still captured. With the proposed implementation, the hardware accelerator can process the full-frame image in a tile-based manner while the down-sampled image can be used for processing each tile, which retains full global context even when the full-frame image is tiled.

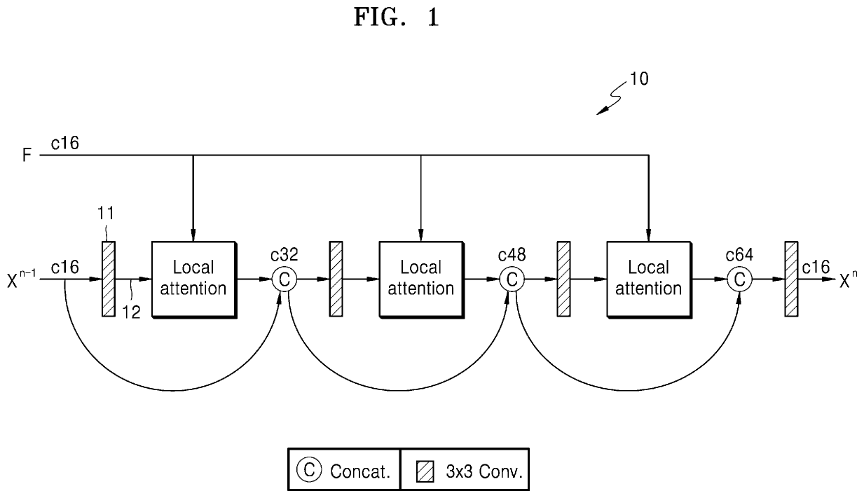

FIG. 1 is an architectural diagram of a hardware accelerator, according to related art. The hardware accelerator (10) includes a first input terminal for receiving a local attention map (F) of a full-frame image, a second input terminal for receiving each tile (Xⁿ⁻¹) of the full-frame image, and an output terminal for providing core features (Xⁿ) of the full-frame image. The hardware accelerator (10) includes 3×3 convolution layers (3×3 Cony.), and local attention blocks connected by performing an operation such as concatenation (Concat.). The first 3×3 convolution layer (11) of the hardware accelerator (10) receives each tile. Node (12) of the hardware accelerator (10) receives an output of the first 3×3 convolution layer (11).

The hardware accelerator may be also limited in functionality and lacks many novel improvements to deep learning especially transformer-based global attention. The transformer-based global attention may be state-of-the-art (SOTA) for most deep learning-based image processing use cases as the transformer-based global attention has a maximum receptive field of infinity. As the full-frame image is required for determining the global attention for each pixel, a runtime-memory requirement for determining the global attention for processing ultra-high definition or high-definition image inputs is extremely high.

The hardware accelerator has a very stringent memory requirement and usually processes the full-frame image in a tile-based manner. The quality of the global attention deteriorates when the full-frame image is executed in a tile-based manner as the receptive field is restricted when input is tiled. Due to this limitation, it is extremely challenging to integrate global attention into neural-network with hardware accelerators. Thus, it is desired to provide a memory-efficient computation of the global attention for the hardware accelerator.

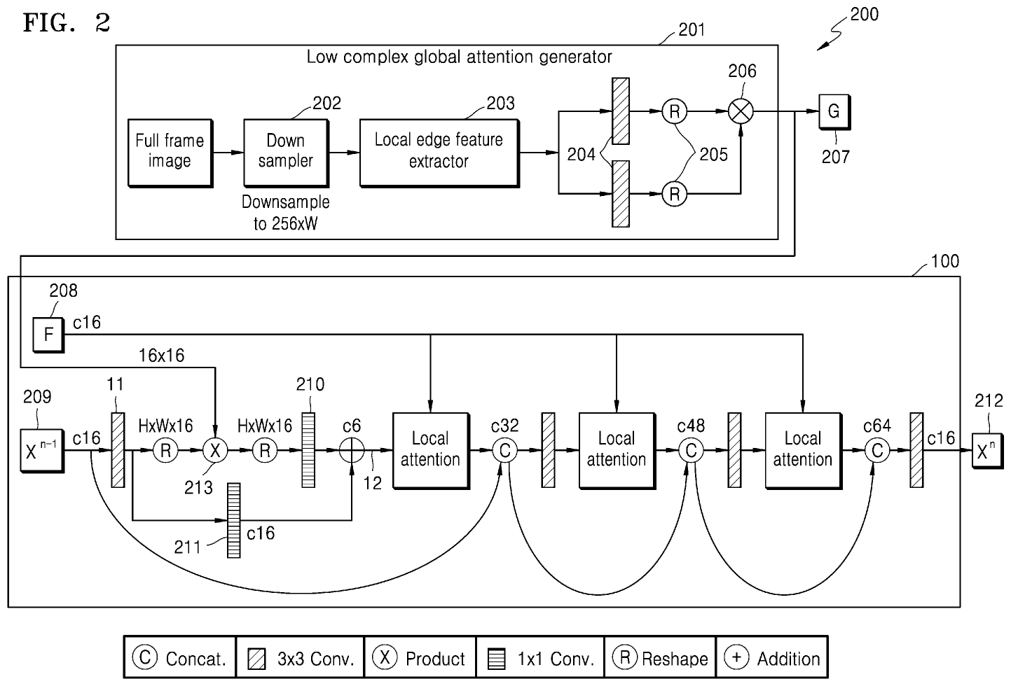

Referring now to the drawings, and more particularly to FIGS. 2, 3A, 3B, 4A, and 4B, there are shown some embodiments of the disclosure.

FIG. 2 is an architectural diagram of an electronic device for determining global attention in a deep learning model in a low complex manner and switching the global attention, according to an embodiment of the disclosure.

Referring to FIG. 2, the electronic device (200) includes a low complex global attention generator (201), and a hardware accelerator (100). Additionally, the electronic device (200) includes a memory, a processor, and a communicator (not shown in figures). The low complex global attention generator (201) includes a downsampler (202), a local edge feature extractor (203), two 1×1 convolution layers (204), two reshaping layers (205), and a first multiplier (206). The downsampler (202) subsamples (e.g., downscales, downsizes, performs size reduction) a full-size image using fixed down sampling kernels (e.g., bicubic, bilinear, lanczos3, lanczos5) or learned downsizing kernels (e.g., strided convolutions). For example, consider a full-size image with a resolution H×W in which H is the maximum dimension, where H is height of the input image and W is width of the input image. When H is downscaled to 256 (not limited to 256), then W is downscaled to 256*W/H for maintaining an aspect ratio of the full-size image. 256 is an example value for the maximum dimension. The maximum dimension could be any value permissible by hardware memory constraints.

Further, the low complex global attention generator (201) may perform a singular and independent determination of a channel attention map (G) (which is also called as a global attention map) by providing the subsampled image to the deep learning model. Determination of the channel attention map is singular and independent because the generation of the channel attention map is a onetime computation and it is independent of number of hardware accelerator blocks. Also, the same attention map is used in every hardware accelerator block.

In an embodiment of the disclosure, the deep learning model includes a local edge feature extractor (203) to extract local edge features of the full-size image, two 1×1 convolution layers (204), and two reshaping layers (205). The extracted local edge features are parallelly fed to the two 1×1 convolution layers (204). The outputs of the two 1×1 convolution layers (204) are further reshaped using the two reshaping layers (205), where the reshaping helps with organizing the feature maps for further operations. Further, the low complex global attention generator (201) multiplies the reshaped outputs using the first multiplier (206) to generate the channel attention map (G) (207).

The subsampling is performed to ensure that the memory requirement for calculating the global attention map is reduced. Initially, the full-size image may be processed sequentially in an overlapped tile based. The low complex global attention generator (201) applies the channel attention map (G) (207) to intermediate deep learning features obtained while processing each tile of the full-size image. As the deep learning features are produced between the input and the final feature map, hence the deep learning features termed as the intermediate deep learning features.

The full-frame image is divided into M×M overlapping tiles for providing to the hardware accelerator (100), where M (e.g., 1, 2, 3 etc.) is dependent on memory constraints of the hardware accelerator (100). Each tile is processed by the hardware accelerator (100) and all the processed tiles are further stitched together by the hardware accelerator (100) to get the output image.

The hardware accelerator (100) includes at least one of a first input terminal (208) for receiving a local attention map (F) of the full-frame image, a second input terminal (209) for receiving each tile (Xn−1) of the full-frame image, third input terminal for receiving the channel attention map(207), a series switch (210), a parallel switch (211), and an output terminal (212) for providing core features (Xn) of the full-frame image.

According to an embodiment of the disclosure, the core features (Xn) are determined based on use case or type of loss function. For example, feature maps for denoising use cases included in the core features (Xn) may represent at least one of strong edges, color component, or noise level.

The local attention map (F) can be any guiding information to the hardware accelerator (100) depending on the application such as denoising or super resolution etc. In super resolution example, the local attention map (F) can be edge and texture map of the image obtained using traditional signal processing or artificial intelligence based techniques. The core features (Xn) are extracted by the hardware accelerator (100) are dependent on an end application such as image super resolution and image denoising etc.

The hardware accelerator (100) further includes 3×3 convolution layers (3×3 cony.) and local attention blocks connected by performing an operation such as concatenation. The hardware accelerator (100) determines core features (Xn) of the full-frame image by processing the local attention map, the channel attention map, and each tile of the full-frame image.

A first 3×3 convolution layer (11) of the hardware accelerator (100) receives each tile. One terminal of the parallel switch (211) receives an output of the first 3×3 convolution layer (11). The output of the first 3×3 convolution layer (11) is then reshaped to a dimension H×W×16 and fed to a second multiplier (213).

The second multiplier (213) receives the reshaped output of the first 3×3 convolutional layer (11) and the channel attention map (G). The second multiplier (213) thus, multiplies the received reshaped output of the first 3×3 convolutional layer (11) and the channel attention map (G). The output of the second multiplier (213) is further reshaped to a dimension H×W×16.

One terminal of the series switch (210) receives the reshaped output of the second multiplier 213. Further, the outputs from other terminals of the parallel switch (211) and the series switch (210) are added and fed to a node (12) of the hardware accelerator (100).

In an embodiment of the disclosure, the parallel switch (211) and the series switch (210) include convolution layers of 1×1 kernel size with non-trainable weights. The parallel switch (211) bypasses a connection of the channel attention map (G) with the hardware accelerator (100). The parallel switch (211) blocks a residual bypass when the global attention is required (i.e. global attention is ON), whereas the parallel switch (211) allows the residual bypass when the global attention is not required (i.e. global attention is OFF). The series switch (210) gates the connection of the channel attention map (G) with the hardware accelerator (20). The series switch (210) allows a flow of the channel attention map (G) when global attention is required, whereas the series switch (210) blocks the flow of the channel attention map (G) when global attention is not required. According to an embodiment of the disclosure, whether a global attention is required or not is identified based on global information including low-light information.

TABLE 1

| | Global attention | Global attention |
|---|---|---|
| | required | not required |
| Attention input ‘G’ | Trained | Zero vector |
| Series switch | Identity vector | Zero vector |
| Parallel switch | Zero vector | Identity vector |

In an embodiment of the disclosure, a generic global attention generator can also be used instead of the low complex global attention generator (201) for computing the global attention of the full-size image, whereas a computational and power requirement for computing the global attention using the generic global attention generator is high compared to the computational and power requirement of the low complex global attention generator (201).

The memory stores instructions to be executed by the processor. The memory may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory may, in some examples, be considered a non-transitory storage medium. The term “non-transitory”may indicate that the storage medium is not embodied in a carrier wave or a propagated signal. However, the term “non-transitory” should not be interpreted that the memory is non-movable. In some examples, the memory can be configured to store larger amounts of information than its storage space. In certain examples, a non-transitory storage medium may store data that can, over time, change (e.g., in Random Access Memory (RAM) or cache). The memory can be an internal storage unit or it can be an external storage unit of the electronic device (200), a cloud storage, or any other type of external storage.

The processor is configured to execute instructions stored in the memory. The processor may be a general-purpose processor, such as a Central Processing Unit (CPU), an Application Processor (AP), or the like, a graphics-only processing unit such as a Graphics Processing Unit (GPU), a Visual Processing Unit (VPU) and the like. The processor may include multiple cores to execute the instructions. The communicator is configured for communicating internally between hardware components in the electronic device (200). Further, the communicator is configured to facilitate communication between the electronic device (200) and other devices via one or more networks (e.g. Radio technology). The communicator includes an electronic circuit specific to a standard that allows wired or wireless communication.

Although the FIG. 2 shows the hardware components of the electronic device (200) but it is to be understood that other embodiments are not limited thereon. In other embodiments, the electronic device (200) may include less or a greater number of components. Further, the labels or names of the components are used only for illustrative purpose and does not limit the scope of the disclosure. One or more components can be combined to perform same or substantially similar function for determining the global attention in the deep learning model.

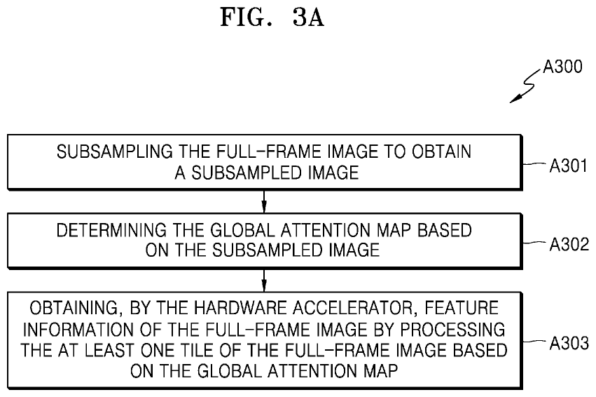

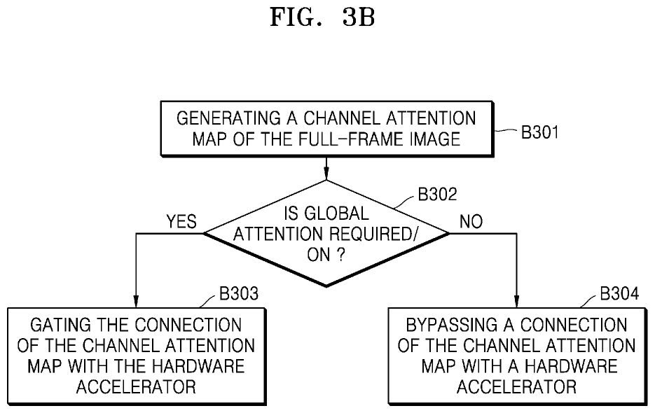

FIG. 3A is a flow diagram illustrating a method for determining the global attention in the deep learning model, according to an embodiment of the disclosure.

Referring to FIG. 3A depicting the flow diagram A300, the method allows the low complex global attention generator (201) to perform operations A301-A302 of the flow diagram (A300). In an embodiment, the method allows the hardware accelerator (100) to perform operation A303 of the flow diagram (A300). At operation A301, the method includes subsampling the full-frame image to obtain a subsampled image. For example subsampling the full-frame image may be performed by using the fixed down sampling kernels or the learned downsizing kernels. At operation A302, the method includes determining the global attention map based on the subsampled image. The singular and independent determination of the channel attention map may be performed by providing the subsampled image to the deep learning model. At operation A303, the method includes obtaining, by the hardware accelerator, feature information of the full-frame image by processing the at least one tile of the full-frame image based on the global attention map. The low complex global attention generator (201) may apply the channel attention map to intermediate deep learning features obtained while processing each tile of the full-frame image.

FIG. 3B is a flow diagram illustrating a method for the switchable global attention, according to an embodiment of the disclosure.

Referring to FIG. 3B depicting the flow diagram B300, the method allows the low complex global attention generator (201) to perform operation B301 of the flow diagram (B300), the series switch (210) to perform operations B302, B303 of the flow diagram (B300), and the parallel switch (211) to perform operations B302, B304 of the flow diagram (B300). At operation B301, the method includes generating the channel attention map of the full-frame image. The channel attention map may include a global attention map. At operation B302, the method includes determining whether global attention is required or not for a use case. At operation B303, the method includes gating the connection of the channel attention map with the hardware accelerator (100) when global attention is required for the use case. At operation B304, the method includes bypassing the connection of the channel attention map with the hardware accelerator (100) when global attention is not required for the use case.

The various actions, acts, blocks, operations, or the like in the flow diagrams (A300, B300) may be performed in the order presented, in a different order, or simultaneously. Further, in some embodiments, some of the actions, acts, blocks, operations, or the like may be omitted, added, modified, skipped, or the like without departing from the scope of the disclosure.

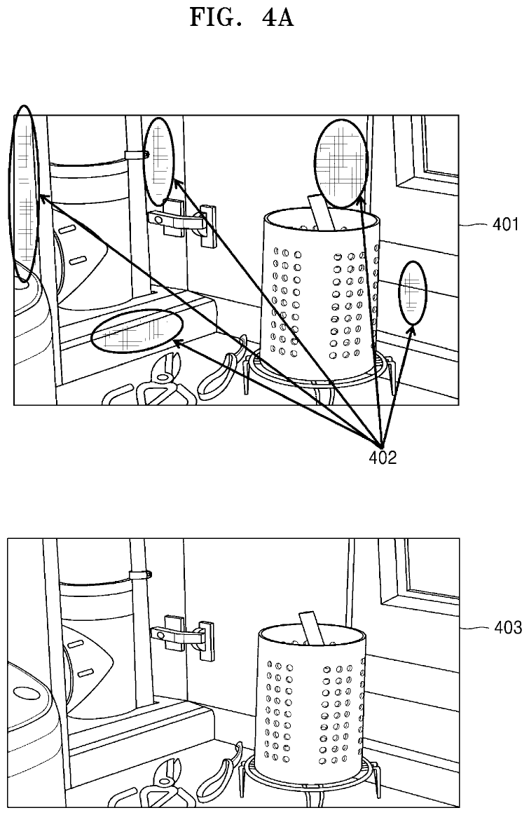

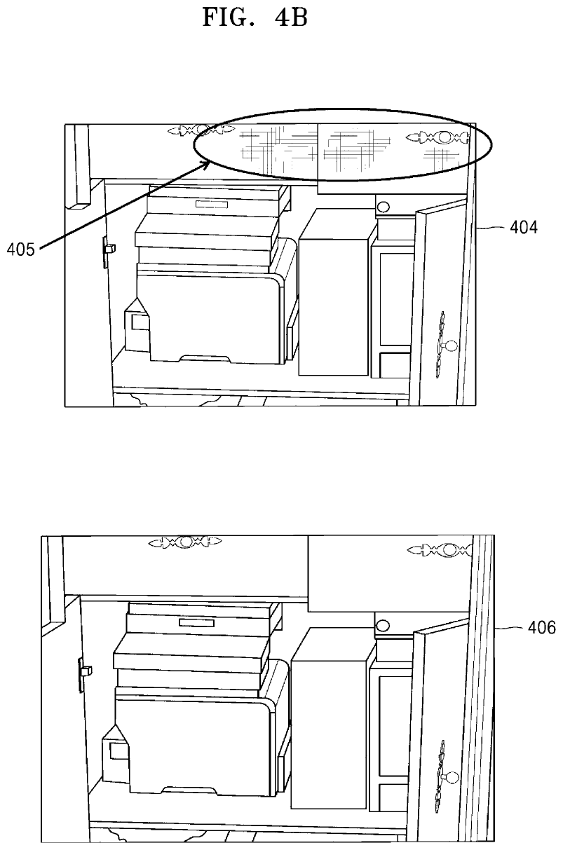

FIGS. 4A and 4B illustrate example scenarios of processing the full-frame image using global attention, according to various embodiments of the disclosure.

Referring to the FIG. 4A, 401 shows a first full-frame image 401 including a few objects placed in a kitchen, in which 402 represents a black shadow present in the first full-frame image 401 as a result of capturing the first full-frame image 401 under low lighting conditions. The proposed electronic device (200) determines the global attention for the first full-frame image 401 and processes the first full-frame image 401 using the global attention for removing the black shadow, resulting in a first rectified image 403.

Referring to the FIG. 4B, 404 shows a second full-frame image 404 including a few objects placed on a shelf, in which 405 represents a black shadow present in the second full-frame image 404 as a result of capturing the second full-frame image 404 under low lighting conditions. The proposed electronic device (200) determines the global attention for the second full-frame image 404 and processes the second full-frame image 404 using the global attention for removing the black shadow, resulting in a second rectified image 406.

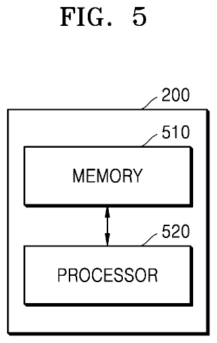

FIG. 5 is a block diagram of the electronic device (200) determining a global attention map, according to the embodiments of the disclosure. Referring to the FIG. 5, the electronic device (200) may be but not limited to a laptop, a palmtop, a desktop, a mobile phone, a smart phone, Personal Digital Assistant (PDA), a tablet, a wearable device, an Internet of Things (IoT) device, a virtual reality device, a foldable device, a flexible device, a display device and an immersive system.

In an embodiment, the electronic device (200) includes a memory (510), a processor (520). the electronic device (200) may further include a hardware accelerator(not shown). The hardware accelerator may include but not limited to Graphics Processing Unit (GPU), Digital Signal Processor (DSP), Field-Programmable Gate Array (FPGA), Tensor Processing Unit (TPU), Application-Specific Integrated Circuit (ASIC), Network Interface Card (NIC), Digital Signal Processing Unit (DSU), Cryptographic Accelerator, Video Processing Unit (VPU), Compression and Decompression Engine, Machine Learning Accelerator and Quantum Processing Unit (QPU).

The memory (510) is configured to store multiple images received as an input. The memory (510) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

In addition, the memory (510) may, in some examples, be considered a non-transitory storage medium. The term “non-transitory” may indicate that the storage medium is not embodied in a carrier wave or a propagated signal. However, the term “non-transitory” should not be interpreted that the memory (510) is non-movable. In some examples, the memory (510) is configured to store larger amounts of information. In certain examples, a non-transitory storage medium may store data that can, over time, change (e.g., in Random Access Memory (RAM)).

The processor (520) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (520) may include multiple cores and is configured to analyze the stored multiple images in the memory (510).

For standard implementation, memory consumption scales linearly with the size of the full-frame image and a count of core blocks in the deep learning models, whereas the memory consumption remains constant for the proposed global attention computation implementation.

The embodiments of the disclosure can be implemented using at least one hardware device to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

While the disclosure has been shown and described with reference to various embodiments thereof, it will be understood by those skilled in the art that various changes in form and details may be made therein without departing from the spirit and scope of the disclosure as defined by the appended claims and their equivalents.

In accordance with an aspect of the disclosure, an electronic device for determining global attention in a deep learning model is provided. The electronic device includes a hardware accelerator configured to process each tile of a full-frame image and a low complex global attention generator. The low complex global attention generator is configured to subsample the full-frame image using at least one of down sampling kernels or learned downsizing kernels, determine a channel attention map by providing the subsampled image to the deep learning model, and apply the channel attention map to deep learning features obtained while processing each tile of the full-frame image.

In an embodiment of the disclosure, where determining the channel attention map by providing the sub sampled image to the deep learning model includes extracting local edge features in the subsampled image, creating two branches of the local edge features, performing a 1×1 convolution and reshaping on each branch of the two branches of the local edge features, and determining the channel attention map by finding a product of the reshaped local edge features.

In an embodiment of the disclosure, where the hardware accelerator is configured for obtaining a local attention map of the full-frame image. The hardware accelerator is configured for determining the core features of the full-frame image based on the local attention map, the channel attention map, and each tile of the full-frame image to the hardware accelerator.

In accordance with an aspect of the disclosure, an electronic device with switchable global attention is provided. The electronic device includes the hardware accelerator, a global attention generator, a parallel switch, and a series switch, where the hardware accelerator is configured for processing each tile of a full-frame image. The global attention generator is configured for generating the channel attention map of the full-frame image. The parallel switch is configured for bypassing a connection of the channel attention map with the hardware accelerator. The series switch is configured for gating the connection of the channel attention map with the hardware accelerator.

In an embodiment of the disclosure, the series switch allows a flow of the channel attention map when global attention is required and the series switch blocks the flow of the channel attention map when global attention is not required.

In an embodiment of the disclosure, the parallel switch blocks a residual bypass when global attention is required and the parallel switch allows the residual bypass when global attention is not required.

In an embodiment, where the parallel switch and the series switch include convolutions of 1×1 kernel size with non-trainable weights.

In accordance with an aspect of the disclosure, a low-complex method for determining the global attention in the deep learning model of the electronic device is provided. The method includes subsampling, by the electronic device, the full-frame image using the fixed down sampling kernels or the learned downsizing kernels. The method includes determining, by the electronic device, a channel attention map by providing the subsampled image to the deep learning model and applying, by the electronic device, the channel attention map to deep learning features obtained while processing each tile of the full-frame image.

In accordance with an aspect of the disclosure, a method for determining the global attention in the deep learning model of the electronic device using the low-complex network is provided. The method includes receiving an input image and sub-sampling the input image to get a sub-sampled image. The method also includes reducing a size of the sub-sampled image using down sampling or downsizing kernels and determining an attention map using the reduced sub-sampled image. Further, the method includes obtaining a set of predetermined deep learning features from at least a portion of the input image and applying the calculated attention map to the obtained set of predetermined deep learning features.

Other aspects, advantages, and salient features of the disclosure will become apparent to those skilled in the art from the following detailed description, which, taken in conjunction with the annexed drawings discloses various embodiments of the disclosure.

1. An electronic device determining a global attention map, wherein the electronic device comprises:
a hardware accelerator, configured to process at least one tile of a full-frame image;
a memory configured to store instructions; and
at least one processor, when executing the stored instructions, is configured to:
subsample the full-frame image to obtain a subsampled image,
determine the global attention map based on the subsampled image, and
obtain, by the hardware accelerator, feature information of the full-frame image by processing the at least one tile of the full-frame image based on the global attention map.

2. The electronic device of claim 1, wherein the determining of the global attention map based on the subsampled image, comprises:
extracting local edge features from the subsampled image;
generating one or more branches of the local edge features;
reshaping on the one or more branches of the local edge features; and
determining the global attention map based on the reshaped local edge features.

3. The electronic device of claim 1, wherein the hardware accelerator is further configured to:
obtain a local attention map of the full-frame image;
determine core features of the full-frame image based on the local attention map, the global attention map, and at least one tile of the full-frame image; and
obtain feature information of the full-frame image including the core features.

4. The electronic device of claim 1, wherein the electronic device further comprises at least one of:
a parallel switch, configured to bypass a connection of the global attention map with the hardware accelerator; or
a series switch, configured to gate the connection of the global attention map with the hardware accelerator.

5. The electronic device of claim 4, wherein the series switch is configured to:
allow a flow of the global attention map in case that the global attention map is required, and
block the flow of the global attention map in case that the global attention map is not required.

6. The electronic device of claim 4, wherein the parallel switch is configured to:
block a residual bypass in case that the global attention map is required, and
allow the residual bypass in case that the global attention map is not required.

7. The electronic device of claim 4, wherein at least one of the parallel switch and the series switch comprises convolutions of 1×1 kernel size with non-trainable weights.

8. The electronic device of claim 1, wherein the subsampled image is obtained based on at least one of down sampling kernels or learned downsizing kernels.

9. A method determining a global attention map of an electronic device, wherein the method comprises:
subsampling a full-frame image;
determining the global attention map based on the subsampled image; and
obtaining, by a hardware accelerator of the electronic device, feature information of the full-frame image by processing at least one tile of the full frame image based on the global attention map.

10. The method of claim 9, wherein the determining of the global attention map based on the subsampled image, comprises:
extracting local edge features from the subsampled image;
generating one or more branches of the local edge features;
reshaping on the one or more branches of the local edge features; and
determining the global attention map based on the reshaped local edge features.

11. The method of claim 9, wherein the method further comprises:
obtaining a local attention map of the full-frame image; and
determining core features of the full-frame image based on the local attention map, the global attention map, and at least one tile of the full-frame image using the hardware accelerator obtaining feature information of the full-frame image including the core features.

12. The method of claim 9, wherein the method further comprises:
allowing a flow of the global attention map in case that the global attention map is required, and
blocking the flow of the global attention map in case that the global attention map is not required.

13. The method of claim 12, wherein the method further comprises:
identifying whether the global attention map is required or not, based on global information of the full-frame image including low-light information.

14. The method of claim 9, the subsampled image is obtained based on at least one of down sampling kernels or learned downsizing kernels.

15. A non-transitory computer readable medium containing instructions that, when executed, cause at least one processor of an electronic device to perform operations corresponding to the method of claim 9.

16. A non-transitory computer readable medium containing instructions that, when executed, cause at least one processor of an electronic device to perform operations corresponding to the method of claim 10.

17. A non-transitory computer readable medium containing instructions that, when executed, cause at least one processor of an electronic device to perform operations corresponding to the method of claim 11.

18. A non-transitory computer readable medium containing instructions that, when executed, cause at least one processor of an electronic device to perform operations corresponding to the method of claim 12.

19. A non-transitory computer readable medium containing instructions that, when executed, cause at least one processor of an electronic device to perform operations corresponding to the method of claim 13.

20. A non-transitory computer readable medium containing instructions that, when executed, cause at least one processor of an electronic device to perform operations corresponding to the method of claim 14.
